(19) United States
(12) Patent Application Publication
(10) Pub. No.: US 2024/0287962 A1
(43) Pub. Date: Aug. 29, 2024

(54) VERTICAL AXIS WIND POWER SYSTEM AND METHOD

(71) Applicant: David Robert Nygren, Arlington, TX (US)

(72) Inventor: David Robert Nygren, Arlington, TX (US)

(21) Appl. No.: 18/581,726

(22) Filed: Feb. 20, 2024

Related U.S. Application Data
(60) Provisional application No. 63/447,824, filed on Feb. 23, 2023.

(51) Int. Cl. F03D 3/00; F03D 9/25

(52) U.S. Cl. CPC F03D 3/005; F03D 9/25; F05B 2220/706; F05B 2240/211; F05B 2270/32

(57) ABSTRACT

A vertical-axis wind power machine has adaptive airfoils to extract energy at low to moderate wind speeds, and also at higher speeds. The systems and methods described herein employ control system techniques to manage large, variable-area sails, which can be made of durable flexible fabric, such as that used in modern sailboats. To match wind conditions, sail area can be adjusted through furling and unfurling techniques. For low wind speeds, the sails can be mostly or fully unfurled. At higher wind conditions, the sails can be partially furled. For extreme weather conditions, furling is complete. Sail pairs rotate around a central axis to generate electricity.

### CROSS REFERENCE TO RELATED APPLICATIONS

This application claims priority to and the benefit of Provisional Patent Application No. 63/447,824, filed Feb. 23, 2023, the contents of which are incorporated herein by reference in their entirety.

### BACKGROUND OF THE INVENTION

The invention relates generally to a system and method for generating wind power.

Conventional turbine wind energy extraction systems produce power approximately as the third power of wind speed. The typical threshold wind velocity for meaningful operation of such systems is high enough that useful sites are limited. This strong dependence on wind speed and acceleration of blade fatigue at high wind speeds also imposes a limited operating wind speed range. Furthermore, airfoil velocity at the blade tip of a large conventional horizontal turbine design may reach a magnitude several times larger than the wind speed itself, e.g., up to hundreds of kph.

Conventional horizontal-axis wind turbine machines vary both blade pitch and axis direction to match wind conditions. These adaptive features require extremely robust and hence costly mechanical systems to accommodate huge hub forces. Components of such conventional systems are large and heavy, and installation requires very large construction cranes. Access to remote sites is often impaired. Thus, these wind machines are not suitable for all locations and applications. Nevertheless, these machines will dominate wind energy and have increased rapidly worldwide over the last few decades.

Wind power has been in use for centuries. However, even after all these centuries of windmill use, there remains a need for a novel and attractive approach to the extraction of wind energy. For example, there is a need for wind machines that are more visually appealing and less disorienting than the familiar horizontal-axis wind turbines. There is also a need for installations at remote hilltops, isolated farms, semi-urban, or even in urban settings on top of e.g., big box stores and warehouses, that cannot be accomplished with conventional systems.

Wind energy can be taken as inexhaustible and the highest possible energy extraction efficiency is not always the primary technical goal. From a practical use implementation and business perspective, it can be more important to provide a machine that, for a given total investment, delivers an attractive anticipated yield of annualized kWH for the number of years a machine may be expected to remain in operation. The economic balance must weigh the scale of installation, depreciation allowances, and profits from electricity generation against costs of design, manufacture, installation, operation, maintenance, and end-of-life site reclamation. But intangible benefits such as iconic value and visual appeal may also be very important.

Accordingly, it is desirable to provide an improved wind power generating machine, system and method, which overcomes shortcomings of the prior art.

### SUMMARY OF THE INVENTION

Generally speaking, in accordance with the invention, a vertical-axis wind power machine is provided, with adaptive airfoils to extract energy at low to moderate wind speeds, and also at higher speeds. The systems and methods described herein employ control system techniques to manage large, variable-area sails, which can be made of tough flexible fabric, such as that used in modern sailboats. To match wind conditions, sail area can be adjusted through furling and unfurling techniques. For low to moderate wind speeds, the sails can be mostly or fully unfurled. At higher wind conditions, the sails can be partially furled. For extreme weather conditions, furling can be complete and the system can become dormant and protected.

Dynamic angular phasing of each sail is provided to match changing wind directions. A softer dependence on wind speed and a lower threshold for useful wind speed is obtained. The systems and methods provided herein provide both environmental and visual advantages over conventional giant turbines, such as lower noise, enhanced visual impact, and a negligible threat to birds and bats.

As the sails revolve around a central axis, they cause that axis to rotate, similar to typical windmills. This rotation of the central axis is coupled to an electric generation device adapted to generate electricity when the central axis rotates, by any well-known system.

Wind power machines in accordance with the invention, are described to capitalize on the much more pervasive wind energy at lower wind speeds, especially nearer to the ground than where modern turbines operate. The concept is intended to fill niche applications rather than to compete with major installations of wind turbines. Benefits include, low noise, appeal in small-scale rural installations, visual attractiveness and iconic advantage in urban settings.

Accordingly, it is an object of the invention to provide an improved wind power generation device that overcomes drawbacks of existing wind power devices.

Still other objects of the invention will in part be obvious and will, in part be apparent from the specification and drawings. The invention accordingly comprises the composition, device and method which will be exemplified in the structures and methods hereinafter described, and the scope of the invention will be indicated in the claims.

### BRIEF DESCRIPTION OF THE DRAWINGS

For a fuller understanding of the invention, reference is made to the following description, in connection with the accompanying drawings, in which:

FIG. 1 is a top plan view of a wind power generating device in accordance with a preferred embodiment of the invention;

FIG. 2 is a side view of the device of FIG. 1, showing only two of the secondary armatures;

FIG. 3 is a partial top plan view of showing the sails wrapped around a furling tube of the device of FIG. 1;

FIG. 4 is a partial side view of the device of FIG. 1;

FIG. 5 is a partial side view of the device of FIG. 1 and only two (of four) tensioning lines are shown;

FIG. 6 is a partial top plan view of the device of FIG. 1; and

FIG. 7 is a schematic view of a doubly differential winch of the wind power generating device in accordance with a preferred embodiment of the invention.

The drawings are presented for purposes of illustration only. They are not necessarily to scale, and are not to be interpreted as limiting.

### DETAILED DESCRIPTION OF THE PREFERRED EMBODIMENTS

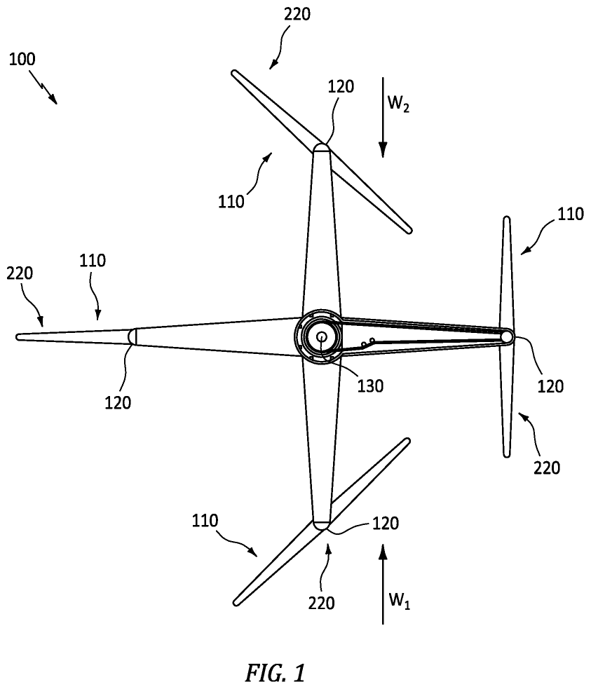

A vertical-axis wind power generator 100 having 4 of a possible N (integer) rotating sails 110 is shown in FIGS. 1-6. Preferably, N=2-6, most preferably 3 or 4. The device includes N secondary armatures, comprising vertical secondary axes of rotation 120 mounted on a rigid central main axis rotor 130. The rotation of central axis 130 is used to generate electricity by any of several known methods.

Secondary axes of rotation 120 are displaced from main axis (main rotor) 130 and preferably symmetrically spaced in angular increments of 2π/N. Main rotor 130 supports N secondary armatures 220 at the N secondary axes 120. Each secondary armature 220 supports a pair of sails 110. Sails 110 are two-part variable sail-pairs that capture wind energy during rotation about secondary axis 120. Main rotor 130 is supported by a static main support structure 130′ that also houses a power conversion unit 140. For illustration purposes, the wind is blowing in the direction or arrows W₁ or W₂. In FIG. 1, if the wind direction is W₂, rotation is counterclockwise; if W₁, clockwise.

### Main Rotor

Main rotor 130 provides robust mechanical support to secondary axes 120. In one embodiment of the invention, main rotor 130 also supports the elements of phase control, as described below. Main rotor 130 also provides a mechanical connection through a vertical axle to power conversion unit 140. It is supported through bearings that tolerate gravitational, wind and dynamic force loads.

### Sail Furling

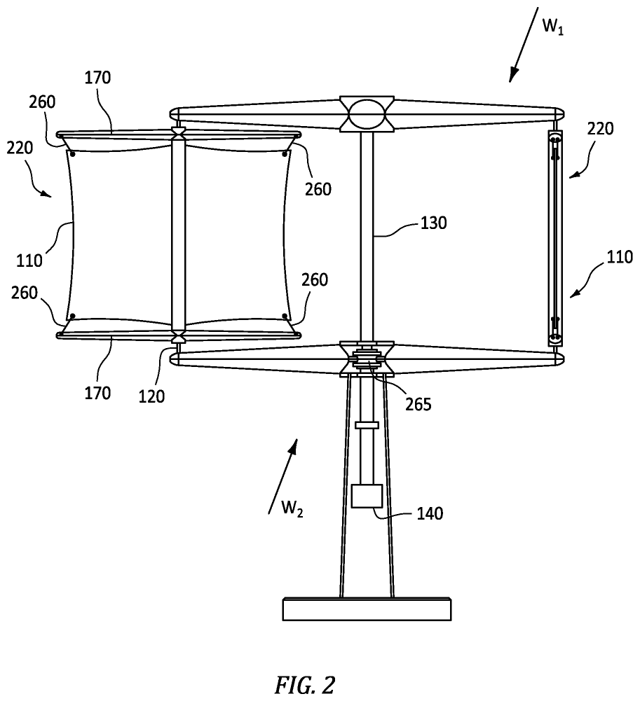

In FIG. 2, for clarity, only two of the secondary armatures are shown. Wind direction is either into or out of the page. One sail-pair 110, maximum area shown here, is running downwind, and the other, edge-on here, is running into the wind. One set of main axis bearings is indicated. Another set of lower main axis bearings, not shown, can be useful to balance transverse forces on the main shaft.

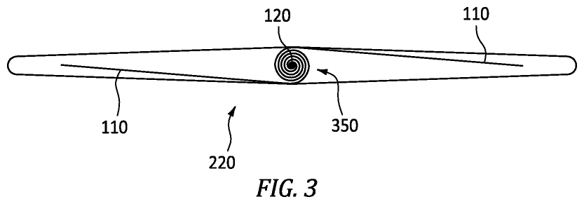

Management of the unfurled area of sails 110 is accomplished by a furling tube mechanism 350, concentric with secondary axis 120, as shown in FIGS. 3, 4 and 6. Furling tube 350 allows sails 110 to unfurl and be largely or even fully open at low wind speeds, furled partially at moderate wind speeds or furled completely at excessively high wind speeds, and any increment therebetween. Partial furling may be necessary in particularly high wind conditions when maximum power output can be attained with less than maximum sail area, for the protection of device 100. Complete furling is appropriate under adverse or becalmed weather conditions. The two sail parts wind up over each other during furling. Furling and unfurling can proceed slowly. Large changes in wind conditions typically emerge relatively slowly. Complete furling or unfurling should require less than five minutes.

The degree of furling of sails 110 of vertical-axis wind power generator 100 will be managed with an electrical furling control system. The furling control system will be linked to a local wind speed measuring device to provide the furling control system with current wind speed data. In addition, current and projected wind speed data can be obtained from the internet. Furling will be automatic under control of the furling control system. The system can measure the tension in the lines and compare that tension resulting from the actual force of the wind on sails 110 as well to compare what the sails are experiencing with what the weather information (current and/or projected) is providing. Monitoring can easily be continuous or at specified short, periods. In practice, furling or phase adjustments are likely to occur perhaps every half hour under typical conditions, with normal weather variations. However, under some sudden local change, the system would automatically act instantly on its own.

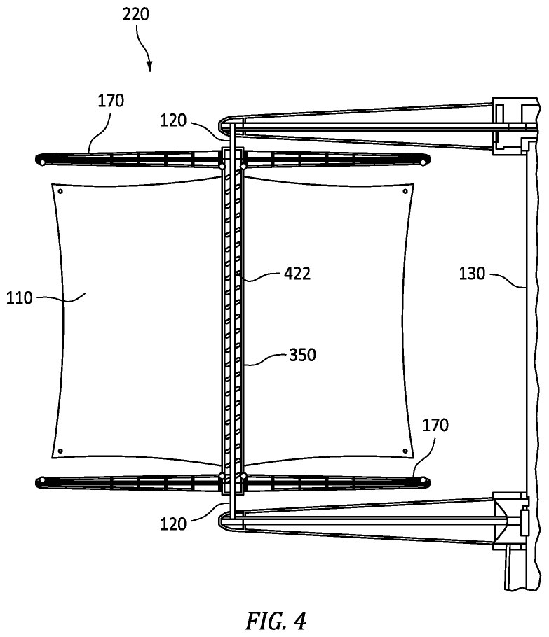

FIG. 4 depicts secondary armature 220, a pair of sails 110 and furling tube 350 in elevation view. Furling tube 350 encloses helical spring 442, tension biased to wind up sail-pair 110 as allowed by the extension of tensioning lines 260 shown in e.g., FIG. 2 when the wind speed increases. One end of spring 442 is connected to furling tube 350, while the other is fastened to axle 120. Axles 120 are connected to main rotor 130 and constrained to rotate at ½ angular speed of main rotor 130, and with a phase determined by wind direction.

Furling/unfurling can be effectuated by four wires (or lines) 260. Wires (or lines) 260 can be made from steel or polymers such as nylon or polypropylene. Tensioning wires/lines 260 are connected through an arrangement of guides and pulleys 265 that guide wires or lines 260 to a doubly differential winch (DDW) mechanism 266. DDW 266 provides equal tension to each of the four lines 260 controlling extension of a sail-pair 110, regardless of the extension of any individual line 260. This feature accommodates inevitable dimensional variations in sail construction and furling. Wires or lines 260 should reliably traverse the distance from DDW 266 to an arrangement of vertices of outrigger arms 170 of secondary armatures 220 through an arrangement of unjammable pulleys and guides.

Furling tube mechanism 350 includes three concentric elements:

The innermost element is a central shaft 120 of secondary armature 220 that transmits rotation and phase to sails 110, and transmits transverse force to main rotor 130.

The next element radially is a helical coil spring 422, shown in FIG. 4. Spring 422 provides the furling torque for furling tube 350 against the force of tension lines 260, which unfurl sails 110. Helical coil spring 422 is designed to provide appropriate torque through furling tube 350 to “wind up” both half-sails of sails 110 at any extension amount of sail 110 as wind forces balance the tension of lines 260. The maximum tension from spring 422 occurs when sail 120 is fully unfurled. Helical coil 422 spring is connected at one of its ends to secondary armature axis 120, with the other end connected to the outermost element, furling tube 350. Tension in lines 260, which control furling, will vary during a full rotation cycle as the sails 110 catch the wind and cause some billowing in sails 110 and small variations in the relative extension of each tension line 260 may occur during the rotation cycle. However, the sum of the extensions in all four lines 260 should remain essentially constant until the controller initiates a furling change due to a change in wind conditions. This feature is a consequence of the action of the doubly differential winch.

Sails 110 are wrapped around furling tubes 350. The diameter of furling tube 350 should be large enough that sail 350 is furled in a reasonable number of turns. The ratio of tensions between maximum and minimum tensions is preferably about 2, with the optimum ratio to be determined by a particular setting and scale. Substantial (temporary) power can be required during furling and unfurling, such as to overcome the force of spring 422. Electrical power can be transferred to the main rotor via slip rings, and then to the secondary armature by a second set of slip rings. Monitoring of mechanical state and function of components can be accomplished by any of several well-known modern slow network methods through the slip rings. In another embodiment of the invention, the furling control system merely measures the tension on lines 260 and furls sails 110 when this tension exceeds a pre-set amount and unfurls sails 110 as the tension on lines 260 falls below a preset amount.

### Secondary Armature

Each secondary armature 220 rotates around its individual secondary axis 120. Secondary armature 220 should be mechanically rugged to support the tensioning and weight of sail (pair) 110, and it must provide for rotation of sail 110 to optimize its angle to wind direction, sail phasing and sail furling. The major element of secondary armature 220 is furling tube 350, which is concentric to secondary axis 120. Furling tube 350 encloses helical coil spring 422 and axle 120 that connects to main rotor 130, as noted above. The purpose of furling tube 350 is to partially or fully wind up sails 110 when high winds or icy conditions exist, protecting them and the structures from excessive forces. As used herein, reference to sail-pair 110 or alternatively sail 110, refer to the same structure.

### Doubly Differential Winch and Line Tensioning

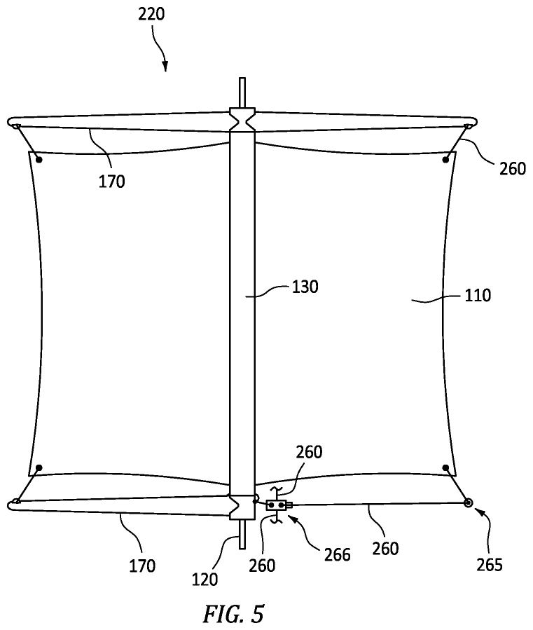

In addition to furling tube 350, secondary armature 220 is equipped with doubly differential winch (DDW) mechanism 266. DDW 266 is adapted to provide equal tension to each of the four tension lines 260 that furl/unfurl the two sails 110 of one of the secondary armatures 260, regardless of the amount of extension. It is important that each of the four corners of sails 110 are pulled with effectively equal force under all conditions and furling extension. The provision of equal force to each of the four corners of a sail-pair 110 accommodates natural dimensional variations in sail fabrication and compensates for relaxation if sail material stretches or otherwise deforms under use. Tension lines 260 reach from DDW 266 via pulleys and guides to the vertices of outrigger arms 170 of secondary armature 220, and then to the corners of each sail-pair 110, as shown, e.g. in FIG. 5.

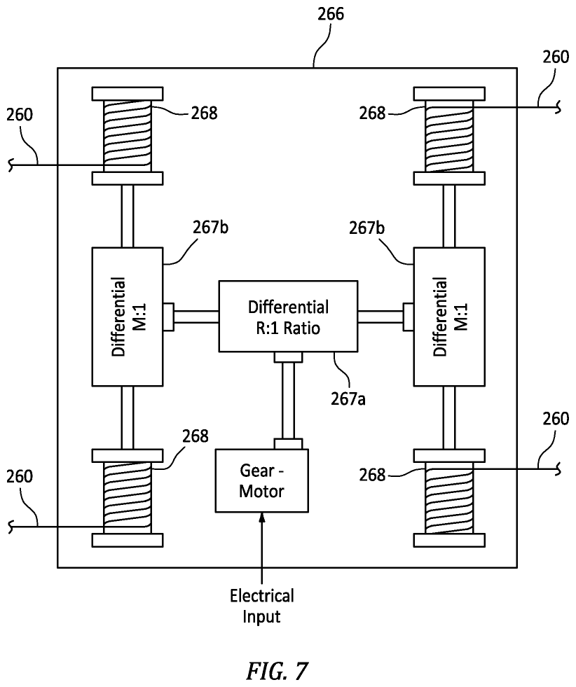

DDW 266 is conceptually equivalent to a set of three interconnected differential gear sets. Referring to FIG. 7, a primary gear set 267a drives two secondary gear sets 267b. Primary gear set 267a can be powered with an electric motor (requiring much less power than is produced with wind power generator 100) and delivers equal torque to secondary gear sets 267b. Each of the two secondary differential gear sets 267b drive two respective drums 268. One tensioning line 260 is wound around each drum 268. This provides a total of four tensioning lines 260 controlled by the motion of primary gear set 267a. In this manner the motion of primary gear set 267a determines the sum of extensions/retractions of the four tension lines 260, and hence the degree of furling/unfurling for the sail pair, while automatically accommodating natural and unavoidable variations in sail corner positions in space.

Primary gear set 267a has an input/output torque ratio R. Secondary gear sets 267b may have different torque ratios M, but all secondary gear sets 267b should have the same torque ratio M. All four lines 260 should have essentially the same tension. Each line 260 extends to a corner of a respective sail 110.

DDW 266 resides on secondary armature 220. Equal force to the four corners of sail 110 is assured by DDW 266 independent of dimensional variations between each half of a sail pair 110 for all furling amounts and wind conditions. This ensures regular and reproducible furling. As unfurling begins, lines 260 from DDW 266 pull with increasing force at the four corners of each two-part sail 110. As force increases, the lines will pull sails 110 to greater unfurling amounts. Tension should be sufficient to prevent excessive flapping or billowing during essentially all operational conditions. Wire or polymer ropes 260 are guided by pulleys from DDW 266 to the vertices of outrigger arms 170 of secondary armature 220. A variable-speed bidirectional electric motor can be used to drive DDW 226. The motor can obtain power through slip rings on secondary armature 220. DDW 226 can be equipped with electrically powered clutches that release on loss of power, allowing the complete managed furling of sails in the case of an emergency fault condition leading to sudden loss of all power.

### Sail Design

Each sail 110 consists of two equal halves to form a sail-pair. Both halves are wound together around furling tube 350 (see, e.g., FIG. 3). Each furling tube 350 presents surface areas that are symmetric relative to its secondary axis, balancing forces to a high degree. The primary action of each sail pair 110 is not to force rotation around its own secondary axis 120, but rather, to present a direct horizontal force that pushes against secondary axis 120 itself. Because secondary axes 120 are displaced radially relative to main axis 130, and because the net transverse force on each secondary axis 120 varies strongly as rotation occurs about main rotor 130, the net result is to force rotation of the main rotor 130, delivering mechanical torque to main axis 130 and allowing conversion to electrical power.

### Sail Rotation

Sails 110 rotate around their axes at half the angular speed of main axis 130. It takes two complete revolutions of main rotor 130 to return a sail 110 to its initial orientation. The sense of rotation around secondary axis 120 is the same as main rotor axis 130.

The maximum projected area of sail 110 occurs when running “downwind” (+90°). A minimum projected sail area should typically occur when running “upwind” (+270°). At angular positions near +180° and 0° (or +360°) of main rotor 130, sails 110 act as conventional airfoils, as any experienced sailor would recognize. Roughly speaking, sails 110 present surfaces that generate positive rotational force for about ¾ of a complete rotation around main axis 130. During the other approximately ¼ of each rotation, the sails approach “luffing” as they move into the wind, i.e., jibing. Even in this case, furling tube 220 maintains sail tension. The outer corners of each half-sail are set according to average wind conditions and may be varied slowly. Power output can be used to charge a local battery (not shown) as power levels may vary significantly during a full cycle of revolution. DC power is then drawn continuously from the battery and converted to AC power synchronized and delivered smoothly to the grid, as is common practice.

### Sail Shape, Edges and Billowing

The corners of sails 110 are the points where furling, or tension, lines 260 connect to sails 110. Sails 110 should have strength lines embedded on their periphery, with additional flexible reinforcing elements embedded as needed. The edges of sails 110 will follow shallow catenary shapes such that appropriate, optimized stress tensor components (not shown) within the sail material are maintained under all conditions of wind. The sails should be shaped such that the embedded peripheral strength cables do not cross over themselves during furling. Sails 110 may experience a small, varying amount of billowing during each revolution of main rotor 130, leading to a small amount of furling/unfurling motion, even though the exterior corners of each sail 110 are held fixed.

### Sail Phasing

The phasing of the sail rotation should be adjustable to orient sails 110 for maximum power extraction for any wind direction. Response can be slow. With the choice of N axes at 2π/N degrees around the main axis, the angular phase of each sail 110 is also displaced by the same angular increment. The concept should take advantage of modern control systems, but nothing need be especially sophisticated or problematic. The torque mechanisms and controllers for this purpose may be a combination of mechanical, electromechanical, or even hydraulic or some hybrid approach. A suitable controller is discussed below.

### Secondary Axis Torque

Although sails 110 are symmetrical around their axes 120, the force balancing between the two halves of each sail 110 is not fully achieved due to varying aerodynamics during a complete rotation. Nevertheless, it seems likely that the sail aerodynamics will lead to secondary axis torques that generally act positively if both furling and secondary axis rotations have the same sense, as suggested in FIG. 1. That is, less power will be needed to maintain sail phasing if same sense rotation is chosen. This may lead to a net energy balance for sail phasing of approximately zero, when averaged over a complete rotation of main rotor 130. In any case, the desired half-angular speed rotation of sails 110 should be manageable with torques likely very much smaller than the net torque developed about the main axis.

### Sail Material

Sails 110 should be made of flexible and durable sailcloth material that will last long enough to realize an acceptably low maintenance interval and cost. Such materials and their maintenance are well known to those of ordinary skill in the art. The sail colors can be chosen for best visual or iconic impact, depending on circumstances.

### Control Systems

An electronic System Control mechanism (not shown) will manage start-up, operation, and shutdown sequences; monitor and adjust operation for maximum energy productivity; sense fault conditions and take appropriate action as needed. Such systems are well known to those of ordinary skill in the art. A low-speed digital network and electric power can be transferred through slip rings at the base of main rotor 130, where it is distributed as needed. A wireless system (not shown) can provide supplementary monitoring and control redundancy. A complete furling of sails 110 can be an automatic part of every shutdown mode. Examples of fault conditions include a loss of connection to grid power, the sensing of a servo function out of tolerance, excessive vibration, or a mechanical, electrical, or monitoring failure, etc. Below is a description of control system functionality.

Variables: Values which are determined either by measurements made regularly at fixed intervals, or through actions by the controller based on the measurements. The variables are hence a mix of dependent and independent values.
Φₘ=the wind machine horizontal “axis” direction, normally set to capture wind energy optimally. Range: 0<Φₘ<2π
The value of Φₘ is set by any suitable method chosen. Φₘ is expected to change slowly, even if wind direction is affected by gusts over short periods.
Φ_{w}=the actual direction of the wind impinging on the wind machine.

$$0 < {Φ}_{w} < 2 π \qquad Range$$

The direction Φ_{w} is determined by nearby instrumentation, with adequate redundancy to minimize single point failure probability.
Δφ=difference between measurements of wind direction Φ_{w} and wind machine axis Φₘ.
Range in normal operation: −Δφₘₐₓ<Δφ<+Δφₘₐₓ Δφₘₐₓ is expected to be set around 10°, but might be made smaller in practice.
Θ=angular value of the output drive shaft of the motor that drives the DDW.
Range: 0<θ<nπ n is expected to be a large number-several tens, e.g. 40-80.
The value of θ is directly related to, and determines, the extent of furling or unfurling through the winding or unwinding of the four tension lines. It is expected that n will be set to be the same for all n DDW units. The value of θ can be measured very accurately by a rotary encoder. For discussion, we specify that the maximum extension of the sails occurs when the value of θ is maximal.
Δθ=measurement error of θ due to the rotary encoder.
This error is negligibly small.
V=local wind speed, likely averaged over a rolling interval of a few minutes.

This measurement is determined by nearby instrumentation, with adequate redundancy to minimize single point failure probability. Input on wind conditions over a larger region can be obtained through an internet connection, to anticipate extreme weather events.

Parameters: Values which are set at run time and are not expected to change, but can be changed under new run design or new operational conditions.
Δφₘₐₓ=the maximum allowed difference between wind direction φ_{w} and wind machine axis φₘ.
This is expected to be set around 10°, but might be made smaller in practice.
Vₘₐₓ=the maximum sustainable average wind speed before complete furling is needed.
Δ=a constant connecting θ and wind speed V.
The connection is made through the functional relationship θ=f(V), where in the simplest case θ=AV+C, where A is negative and C is some numerical constant corresponding to the maximum value of +0 when the wind speed V is zero.
B=a negative constant connecting θ and wind speed V in a more realistic nonlinear function.
θ can be set at θ=AV³+BV²+C.

Operation: Initialization of operation first requires measurements of all local conditions including temperature and history of precipitation. The second step is orientation of the horizontal axis φ such that Δφ is less than Δφₘₐₓ according to stable measurements averaged over several minutes. Once stability in φ and Δφ is demonstrated, the next step is begun. The third step in initialization is to begin unfurling from θ=0 to a value determined by the functional relationship of θ and V. Unfurling occurs in stages which allow assessment of stability in operation and power output at each step.

During operation, measurements can occur every minute to check that θ and φ are within range for maximum safe power output. As average wind conditions change, small changes in φ and θ may be expected. If any variables display instability of out-or-range behavior, indicating extreme weather or a fault, furling can be automatically initiated, leading to safe shutdown. In the event of power loss from the grid, furling can be automatic, as electric clutches (with viscous brakes) that maintain mechanical connection between the primary and secondary differentials would relax, slowly releasing the tension in lines and allowing furling to occur completely, at normal rates.

### Some Implementations of Sail Rotation

The control mechanism must cause the sense of rotation of both main and secondary axes to be the same. Either clockwise or counterclockwise is in principle equivalent, but the sense of the secondary axis and main axis must be the same.

Some distinct “pure” choices exist for possible realization of sail rotation: mechanical, electric, or hydraulic, but hybrid approaches can also be acceptable. Each has advantages and disadvantages, as elaborated below.

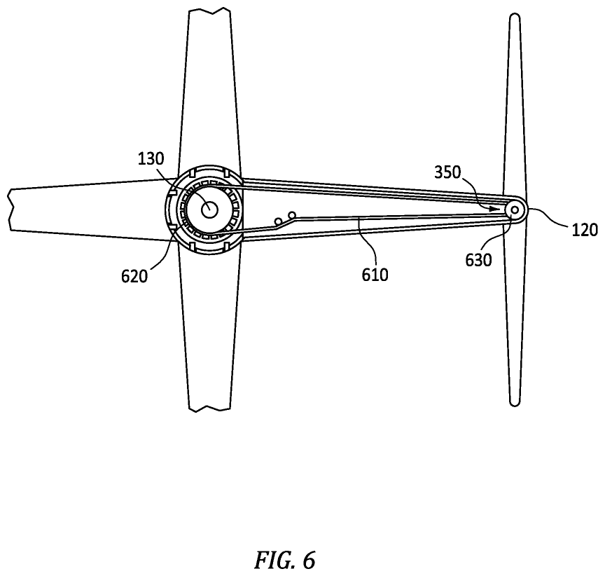

In one “mechanical” approach, rotational force from a sail rotation is transmitted with a metallic chain 610, e.g., a bicycle type chain, that wraps around a sprocket gear 620 concentric with the main support structure axis as shown in FIG. 6. Chain 610 extends outward along the outriggers of main rotor 130 and wraps around another outboard sprocket 630 that is connected to sail support axis 120. Each sail 110 has its own chain 610 and a gearbox to ensure same-sense rotation of the respective secondary armature 120 at half angular velocity. Chain 610 can droop under gravity, likely requiring support idlers (not shown). In any case, idlers with dog legs under tension may be needed to absorb torque impulses during jibe. The gearbox is likely a single planetary gear set, which can match the angular rotation sense and allow for wind direction phase adjustment. The action can be similar to the differential gear set found in automobiles, used here in a different way, and with unequal output.

In another embodiment of the invention, to avoid placing more weight at the outboard location, the gearbox may be located near the central axis. A secondary chain would then connect the gearbox to the secondary armature. The wind direction phase adjustment mechanism can be driven by an electric motor and would operate only if the wind direction changes. As very slow angular speeds would be needed for wind direction phase control, the motor can be relatively small and connect to the gearbox through its own reducer. The gearbox thus provides two substantial benefits, first, matching the angular speed of the secondary axis to ½ that of the main rotor and, second, a means for sail phase adjustment as wind directions require.

In another embodiment of the invention, a variation on the mechanical approach would be to permit the concentric sprocket gear itself to rotate, thereby realizing the phase rotation function. This embodiment eliminates electric motors at the gearbox location, but can require robust mechanics to support and rotate the large concentric sprocket gear. In this case, only sail furling and the myriad monitoring functions would require electrical power within the main rotor/secondary armatures.

One challenge with a pure chain implementation is that a steel chain requires maintenance, such as lubrication and protection from the elements. Although shrouds can likely provide adequate protection from the elements, the shrouds cannot be sealed completely since the main rotor rotates and the chain must contact the main support structure. The advent of variable speed automotive transmissions suggests that modern metallurgy and lubricants might offer a durable solution.

Alternatively, a somewhat more complex implementation could be realized with a single chain that does not fully embrace the sprocket but only contacts the sprocket over a limited angular span. This requires more idlers that would force the chain to contact the concentric sprocket gear of the main-axis support structure. This scenario would offer same-sense rotation of the secondary armature in a straightforward way, but in the absence of other mechanisms, realizing half angular speed requires an outer sprocket of twice the main sprocket diameter.

Another embodiment of the invention employs rubber cog belts instead of steel chains and would allow mechanical sail rotation without lubrication. However, one-piece units might not encircle the sprocket gear in any practical maintenance scenario. N belts would be needed for the machine with several additional idlers to ensure proper belt tension, and the belt must be able to run “inverted” so that cogs are exterior. Alternatively, the chain connecting to the main rotor could be metallic, but the connection from the gearbox to the secondary axis could be a cog belt, running in normal mode.

In another embodiment of the invention, instead of the electro-mechanical scenario with chains or belts, a hydraulic motor, such as those that slowly turn the mix in concrete trucks could be used. There would be no need for direct mechanical reference to the main axis in this case. A hydraulic servomotor would be present at one end of each secondary axis. In this scenario, sail axis rotation and sail phase matching are essentially two functional aspects of the same servomechanism. This scenario requires variable power input and dissipates power. One or N husky hydraulic pumps must exist. In the one pump scenario located at the base a rotating seal must exist, or, if rotating with the main armature, electrical power must be provided to it, an easier function to realize. A further problem with a single pump is that each sail phase should be measured continuously to permit regulation of an appropriate flow of hydraulic fluid through each sail axis motor. Each hydraulic servomotor would thus need to operate under continuous system monitor/control. N pumps seem better as electrical power to each pump would be easily controlled. Pumping and fluid friction losses might be substantial in any configuration.

But then, if not chains, it seems best to avoid hydraulics in favor of an electric motor and gearbox to implement rotation and phasing. Only a gearset needs to located at each secondary axis as the motor could be located nearer the main axis and connect to the secondary axis by a driveshaft.

The control issues should be straightforward. While the power to drive the motors seems explicit, the overall power spent in the rotation/phasing functions may not differ too much between chain, hydraulics and direct electric motor implementations.

A torque-damper may be needed to dissipate transient impulses that occur as a sail will jibe at about 270°, as suggested in FIG. 1. It is nevertheless expected that over a complete revolution, forces on the sails will be naturally well balanced and these gearboxes would provide mainly the desired rotational motion without needing much torque to rotate the sail. It is believed that losses that may occur during a part of the angular cycle will be more than made up during most of the cycle if rotational torque is positive, even providing net positive power, in the sense of regenerative braking in electric cars.

### Snow, Ice, and Rain Conditions:

Rain should not normally be a problem. However, freezing rain and perhaps snow could require shutdown. It is conceivable that the normal flexing of the sails will inhibit buildup of icy deposits on sails; but the other structures, pulleys and lines might be vulnerable.

It will thus be seen that the objects set forth above, among those made apparent from the preceding description, are efficiently attained, and, since certain changes may be made in carrying out the above method and in the devices and compositions set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A wind power generation device, comprising:
a vertical central axis having at least one secondary armature extending radially from the central axis and rotatably mounted to the central axis in a manner to rotate around the central axis;
the secondary armature having a vertical furling tube and a pair of upper and lower outrigger arms extending approximately horizontally in opposite directions radially from a top and a bottom of the furling tube, the outrigger arms having end portions away from the furling tube and being rotatably mounted about the furling tube;
a pair of sails extending radially from the furling tube, each sail of the pair having an upper and a lower outer corner at the far end of the sail away from the furling tube, the furling tube adapted to apply a biasing force to the sails to wind the sails around the furling tube;
the upper and lower outer corners coupled to a respective tension line, each tension line coupled to a tensioning device constructed and adapted to apply an unfurling force and pull on the corners in a manner to unwind the sail from the furling tube;
the sails, outrigger arms, and secondary armature constructed and adapted to rotate around the central axis when wind blows against the sails, and operatively coupled to an electric generation device adapted to generate electricity when the secondary armature rotates around the central axis.

2. The wind power generation device of claim 1, comprising at least three secondary armatures and at least three sail pairs spaced evenly around the central axis.

3. The wind power generation device of claim 1, comprising three to six secondary armatures and three to six sail pairs spaced evenly around the central axis.

4. The wind power generation device of claim 1, wherein the bias force is exerted from a helical spring within the furling tube.

5. The wind power generation device of claim 1, wherein the tensioning device comprises a doubly differential winch, adapted to supply equal tension to each of the tension lines.

6. The wind power generation device of claim 5, wherein the doubly differential winch is mounted on the secondary armature and the tension lines are coupled to the doubly differential winch via an arrangement of pulleys and guides to a plurality of vertices of the secondary armature, and then to the corners of the sails.

7. The wind power generation device of claim 1, and comprising a furling control system constructed and adapted to increase sail furling as wind speed increases and reduce sail furling as wind speed reduces.

8. The wind power generation device of claim 7, and wherein the furling control system is an electronic control system adapted to measure tension on the tension lines and to adjust furling to control the amount of tension on the tension lines.

9. A method of generating wind power from a wind power generation device comprising a vertical central axis having at least one secondary armature extending radially from the central axis, the secondary armature having a vertical furling tube and a pair of upper and lower outrigger arms extending approximately horizontally in opposite directions radially from a top and a bottom of the furling tube, the outrigger arms having end portions away from the furling tube and a pair of sails extending radially from the furling tube, each sail of the pair having an upper and a lower outer corner at the far end of the sail away from the furling tube, comprising:
unfurling the sails during periods of low wind and furling the sails during periods of high wind of a velocity higher than the velocity of the low wind; and
generating electricity as a wind force pushes against the sails and causes the secondary armature to rotate around the central axis.

10. The method of claim 9, comprising furling the sail around the furling tube as wind speeds increase, and unfurling the sail around the furling tube as wind speeds decrease.

11. The method of claim 9, and comprising at least three secondary armatures and at least three sail pairs spaced evenly around the central axis.

12. The method of claim 9, and comprising four to six secondary armatures and four to six sail pairs spaced evenly around the central axis.

13. The method of claim 9, wherein the bias force is exerted from a helical spring within the furling tube.

14. The method of claim 9, wherein the tensioning device comprises a doubly differential winch, adapted to supply equal tension to each of the tension lines.

15. The method of claim 9, wherein, the outrigger arms, and secondary armature rotate around the central axis when wind blows against the sails, and generate electricity when the secondary armature rotates around the central axis.

16. The method of claim 9, wherein furling is adjusted based on changes in wind speed measured with a control device operatively coupled to the furling tube.

17. The method of claim 9, wherein furling is adjusted based on changes in wind obtained from the internet.
